(19) United States
(12) Patent Application Publication
(10) Pub. No.: US 2025/0077876 A1
(43) Pub. Date: Mar. 6, 2025

(54) SUPERVISED MODEL SELECTION VIA DIVERSITY CRITERIA

(71) Applicant: Oracle International Corporation, Redwood Shores, CA (US)

(72) Inventors: Moein Owhadi Kareshk, Burnaby (CA); Giulia Carocari, Zurich (CH); Yasha Pushak, Vancover (CA); Hesam Fathi Moghadam, Sunnyvale, CA (US); Sungpack Hong, Palo Alto, KY (US); Hassan Chafi, San Mateo, CA (US)

(21) Appl. No.: 18/239,416

(22) Filed: Aug. 29, 2023

(51) Int. Cl. G06N 3/09

(52) U.S. Cl. CPC G06N 3/09

(57) ABSTRACT

Techniques for selecting machine-learned (ML) models using diversity criteria are provided. In one technique, for each ML model of multiple ML models, output data is generated based on input data to the ML model. Multiple pairs of ML models are identified, where each ML model in the multiple pairs is from the multiple ML models. For each pair of ML models in the multiple pairs of ML models: (1) first output data that was previously generated by a first ML model in the pair is identified; (2) second output data that was previously generated by a second ML model in the pair is identified; (3) a diversity value that is based on the first and second output data is generated; and (4) the diversity value is added to a set of diversity values. A subset of the multiple ML models is selected based on the set of diversity values.

### TECHNICAL FIELD

The present invention relates to machine learning and, more particularly, to selecting a subset of automatically generated machine-learned models.

### BACKGROUND

Machine-learned (ML) models aim to solve a class of problems for which an efficient algorithmic approach is not solved. Instead of using a step-by-step pre-defined algorithm to solve a task, a machine learning (ML) algorithm extracts hidden patterns from previously-collected data using underlying mathematical structures and stores those hidden patterns in a ML model. While there is a pre-defined ML algorithm (the training algorithm) on how to extract such patterns, the problem is not directly solved in an algorithmic way. For example, there is no known and explicit algorithm to determine home prices. However, using the real-estate data, a ML algorithm creates a mapping between features of homes (e.g., land size, number of bedrooms, etc.) and their prices. The ML algorithm generalizes this mapping in the form of a ML model to predict the price of a new house with known features.

A ML model (mᵢ=(Aᵢ, θᵢ)) is generated from an algorithm Aᵢ which creates a mapping given any set of hyper-parameters θᵢ. Training an ML model is the process of using input data, both input features (X) and the expected outputs (y), to discover the hidden patterns in the input data. The expected outputs can be real-valued (regression problems) or discrete (classification problems).

To perform inference using an ML model means querying the model via unseen data to receive the outputs (oᵢ). A correctness score (Cᵢ) may be assigned to the ML model using a loss function (D(y, oᵢ)) to the ML model. Choosing a proper loss function depends on the task, i.e., regression or classification, and some characteristics of the data, e.g., balanced, or imbalanced. To make the model evaluation process more reliable, the k-fold cross-validation approach may be used. A “good” ML model is the one that achieves the highest correctness score in the lowest training time (tᵢ^{T}) or the lowest inference time (tᵢ^{l}). Typically, there is a trade-off between the correctness of a ML model and its training/inference times.

ML algorithms vastly differ in terms of correctness and performance. Some simpler ML algorithms, such as decision trees and logistic regression, are less computationally expensive than more sophisticated ones, such as random forests or neural networks. However, the more expensive and sophisticated ML algorithms might produce more correct outputs for certain types of data. Furthermore, the chosen values of hyper-parameters for one ML algorithm might result in producing models that substantially differ in correctness or performance. Therefore, to create a good ML model, not only should the right ML algorithm be chosen, but also the right hyper-parameter configuration for that ML algorithm. These decisions depend on the data size and complexity.

The relationships between ML algorithms and their hyper-parameters, and between model correctness and performance, are not trivial. Therefore, the ML algorithm and hyper-parameter spaces need to be searched to find the best model(s). Usually, Bayesian, random, or grid search is used to search the search spaces. However, each of these approaches has its own limitations. Moreover, the optimization criteria are not straightforward to define, and there is often a trade-off between the two above-mentioned criteria: correctness and performance.

Given a set of ML models (mᵢ=(Aᵢ, θᵢ)), “model selection” is the task of choosing one or more ML models according to some pre-defined goals. When model selection involves selecting multiple models, the selected ML models may be used in an ensemble setup. An ensemble is an algorithm that combines the outputs of multiple models and aggregates them to produce a single output yⱼ for the input features Xⱼ.

For classification tasks, hard voter systems (such as majority voting) collect the classes predicted by all models mᵢ for a sample Xⱼ, and pick the most frequently predicted class as yⱼ. Similarly, soft voter systems aggregate the probability that a sample belongs to a certain class, as given by the selected ML models to provide the output yⱼ. For regression, the ensemble can average the outputs of the selected ML models to produce a single prediction.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example model generation and selection system for selecting a subset of ML models, in an embodiment;

FIGS. 2A-2B are a flow diagram that depicts an example process for selecting a strict subset of a set of ML models, in an embodiment;

FIG. 3 is a block diagram that illustrates an example computer system upon which an embodiment of the invention may be implemented;

FIG. 4 is a block diagram of a basic software system that may be employed for controlling the operation of the example computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for selecting ML models are provided. In one technique, each ML model in a set of ML models is given the same input data and each ML model produces output data. The output data of each pair of ML models in a set of ML model pairs is compared to each other to generate a diversity value or score. If the output data of a pair of ML models is the same, then the diversity score of that pair is 0 (or 1), indicating that there is no output diversity for that pair. A subset of the set of ML models is selected that collectively produce the most diverse outputs. Pairs of ML models that have diversity scores that indicate little to no diversity are not likely to be in the selected subset together.

In a related technique, the ML models are also selected based on their respective correctness and/or their respective performance. Thus, there is a trade-off between diversity and correctness/performance. Weights for each metric reflect that trade-off and may be manually chosen or may be default values.

In a related technique, the optimization problem of selecting a proper subset (which is an NP complete problem) may be solved with both classical computing and quantum computing.

Embodiments improve computer-related technology of selecting a proper subset of ML models for use as an ensemble. Embodiments may be used for both classification and regression problems. Also, embodiments may use any loss function or similarity measure to measure the diversity between pairs of ML models. Additionally, in embodiments that involve considering model correctness and/or performance, such metrics and a diversity metric may be calculated in parallel, thus making such embodiments highly scalable. Furthermore, embodiments address the trade-off between correctness and performance, and correctness and model diversity in a way that allows for automatically identifying the number of models that should be included in the ensemble, rather than relying on a user to define the ensemble size. In this way, manually chosen ensemble sizes that are sub-optimal are avoided.

### System Overview

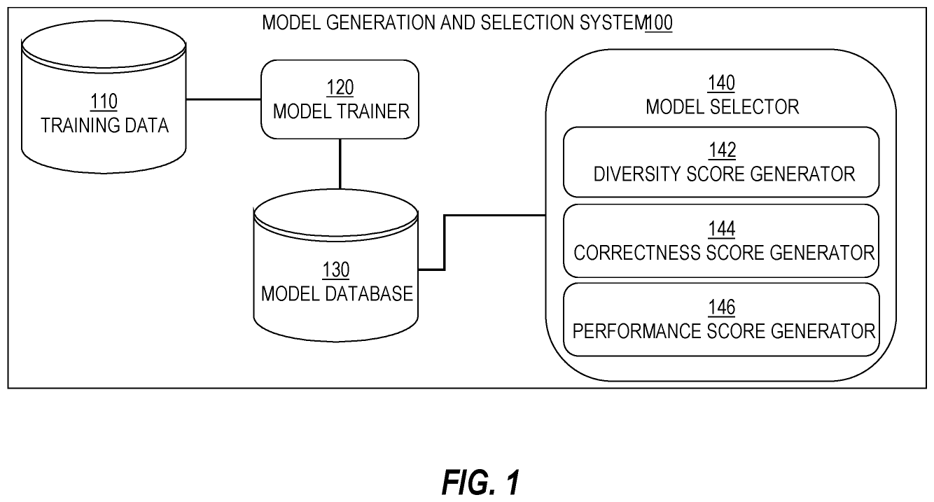

FIG. 1 is a block diagram that depicts an example model generation and selection system 100 for selecting a subset of ML models, in an embodiment. System 100 comprises training data 110, a model trainer 120, a model database 130, and a model selector 140. Each of model trainer 120 and model selector 140 may be implemented in software, hardware, or any combination of software and hardware. Model selector 140 includes a diversity score generator 142 and, optionally, a correctness score generator 144 and/or a performance score generator 146.

Training data 110 comprises multiple training instances that each comprise a set of feature values and an output value. Model trainer 120 reads training data 110 and generates multiple ML models that are then stored in model database 130. The same ML algorithm (e.g., linear regression) may be used to generate the multiple ML models. The difference in the multiple ML models would be based on different hyperparameters. For example, the multiple ML model may be neural networks that have a different number of hidden layers.

Alternatively, different ML algorithms are used to generate the multiple ML models. For example, a support vector machine (SVM) algorithm is used to generate one ML model and linear regression is used to generate another ML model.

Alternatively, different ML algorithms and different hyperparameters are used to generate the multiple ML models. For example, a first ML algorithm is used to generate a first number of ML models and a second ML algorithm is used to generate a second number of ML models, where a different set of hyperparameters is used for each ML model. The types of hyperparameters may vary from one type of ML algorithm to another.

Whichever ML algorithm and set of hyperparameters are used for generating the ML models, the same set of training data is used to train the ML models. This allows the resulting ML models to be equivalent, except for the ML algorithm and/or hyperparameters used.

ML trainer 120 uses a portion of training data 110 to train the ML models. ML trainer 120 uses another portion of training data 110 to validate the ML models. Validating an ML model involves comparing the output of the ML model with the actual answers or expected output. For example, if a ML model predicts a price of a house, then output of the ML model based on input data is compared to an actual answer to determine a difference. The difference represents an error. Model trainer 120 computes an error metric based on all the differences corresponding to the input training instances used for validation.

ML trainer 120 may perform k-fold validation, which is a validation technique that involves splitting the training data into k subsets and performing k trainings, each resulting in a trained model that is trained on different subsets of the training data. However, each model is trained on a different subset of the training data. Also, each of the k subsets is used to test the corresponding trained model (whereas the other k-1 subsets were used to train the model.) For example, if k is three (resulting in subsets k1, k2, and k3), then k1 and k2 are used to train a first model, k2 and k3 are used to train a second model, and k1 and k3 are used to train a third model. The first model is validated based on k3, the second model is validated based on k1, and the third model is validated based on k2.

### Model Selector

Model selector 140 selects, using one or more diversity criteria, a strict subset of models in model database 130. A purpose of one or more diversity criteria is to select a set of ML models that are diverse, i.e., ML models that produce outputs that are different than the others, regardless of their correctness and performance. A reason for using one or more diversity criteria is to use synergism between the selected ML models in an ensemble setup. Diverse (or “uncorrelated”) errors make ensemble learning more effective. According to the type of the machine learning tasks, any loss, similarity, or agreement evaluation function can be used for pairwise model comparisons, i.e., Dᵢⱼ=D(oᵢ, oⱼ).

In an embodiment where Dᵢⱼ is one of multiple selection criteria for selecting multiple ML models, Dᵢⱼ is standardized via z-score normalization, i.e., by subtracting the mean of all values Dᵢⱼ and dividing by their standard deviation. This standardization allows different measures (or selection criteria) to be used and comparable to each other. For example, the diversity of a ML classification model may be compared to the diversity of a ML regression model. Also, z-score standardization makes an optimization process described herein stable.

As Dᵢⱼ=D(oᵢ, oⱼ) indicates, diversity score generator 142 generates a diversity score for each pair of ML models (i and j) in model database 130 (assuming those ML models were trained based on the same training data). Thus, if there are N ML models from which to select, then diversity score generator 142 generates N*(N−1)/2 diversity scores.

A diversity score of a pair of ML models represents how diverse output from the pair of ML models are, given the same input. For example, if two ML models are classification models, the same sets of data are input to the two ML models, each of which produces different output. For example, if the input data comprises one hundred instances of input data, then each ML model produces one hundred instances of output data. To assist in generating a diversity score in a timely manner, the input data to both ML models is ordered the same. In this way, the first output of one ML model corresponds to the first output of the other ML model, the second output of one ML model corresponds to the second output of the other ML model, and so forth.

Then a comparison may be performed to determine a number or percentage of the respective outputs that are the same or different. For example, 98 classifications out of one hundred classifications are the same between the outputs of the two ML models. As another example, 70% of real-valued predictions outputted by one ML model are within 1% of the real-valued predictions outputted by another ML model.

In an embodiment, diversity score generator 142 causes a generated diversity score to be stored in association with the pair of ML models to which the diversity score pertains. For example, model database 130 stores multiple records, each corresponding to a different ML model. Diversity score generator 142 may identify two records pertaining to the two ML models of a pair for which a diversity score pertains and update (or cause to be updated) each of those two records to include the diversity score.

Even if model selector 140 selects a subset of a set of ML models using only one or more diversity criteria, then such selection may be performed in any number of ways. For example, model selector 140 may execute a greedy approach, which involves identifying the pair of ML models with the higher diversity score, indicating the most diverse pair according to one or more diversity measures. Then, for each ML model in the selected pair, a pair associated with the highest diversity score is selected where the pair includes just one of the ML models in the previously-selected pair. This process may repeat until a certain number of ML models is selected or until the cumulative diversity score (of all the selected pairs so far) starts to decrease.

Model selector 140 may be invoked or called by model trainer 120 when model trainer 120 has completely trained all ML models that it plans to train based on a particular set of training data. Alternatively, model trainer 120 informs model selector 140 for each ML model that model trainer 120 trains. Such invoking or calling may include the output data that the ML model in question produced. Alternatively, such invoking or calling may indicate where the ML model is stored in model database 130, which may implicitly or explicitly indicate where the corresponding output data is located (and, optionally, the expected output, which is used to generate correctness scores and/or performance scores, as described in more detail herein).

### Model Correctness

Another criterion for model selection may be to select ML models that also produce the most correct outputs. Correctness score generator 144 generates a correctness score for each of multiple ML models. A correctness score for an ML model is generated by comparing the expected outputs (y) and the output the ML model generates (oᵢ) via a loss, similarity, or agreement evaluation function (L(y, oᵢ)). Examples of correctness measures for classification tasks includes accuracy, precision, area under curve-receiver operating characteristic (AUC-ROC), F-1 score, and recall. Examples of correctness measures for regression include mean absolute error (MAE), mean squared error (MSE), and mean gamma deviance (MGD). Embodiments are not limited to any specific correctness measure. For convenience, it may be assumed that the higher the correctness measure the better. Thus, negative values are used for correctness criteria that measure loss, meaning that lower is better. For example, accuracy may be used as is while the negative value of MSE may be used (since MAE measures loss).

In an embodiment where a correctness score Cᵢ is generated, Cᵢ is standardized via z-score normalization, i.e., by subtracting the mean of all values Cᵢ and dividing by their standard deviation. This standardization allows different correctness measures to be used and comparable to each other. For example, the correctness of a ML classification model may be compared to the correctness of a ML regression model. Also, z-score standardization makes an optimization process described herein stable.

In an embodiment, correctness scores for a set of ML models may be generated concurrently with the generation of diversity scores for pairs of models in that set. The input that generation of a diversity score requires is output from the respective ML models in the corresponding pair. Once the output from one of those ML models is available, a correctness score may also be generated for that ML model. Such parallel generation of the different metrics decreases the time for model selection.

### Model Performance

Another criterion for model selection may to select ML models that are the most performant. Performance may be measured in multiple ways. Examples of an ML model's performance include the time it takes to train the ML model (i.e., “training time”) and the time it takes to generate output given a set of input data (i.e., “inference time”). The set of input data may be a single instance of input data (e.g., to make a single prediction, such as a home price) or may be multiple instances of input data (e.g., to make multiple predictions, such as multiple home prices).

Thus, training time (tᵢ^{T}) and inference time (tᵢ^{l}) may be considered separately as each have a different level of significance according to the application. For example, if an ML model is to be deployed in edge computing (Internet-of-Things) for inference and not training, then inference time would be more important than training time. As another example, if an ML model is a large deep neural network that is trained in the cloud using expensive GPU computing, then training time is more important than inference time. Similar to correctness, the higher value of the performance measure, the better. Example formulas that performance score generator 146 may implement to calculate a performance score include:

$${P}_{i}^{T} = \frac{1}{{t}_{i}^{T}} and {P}_{i}^{I} = \frac{1}{{t}_{i}^{I}}$$

In a related embodiment, a performance measure is based not only on training time or inference time, but also on a correctness measure Cᵢ. Example formulas that take into account training time or inference time are as follows:

$${P}_{i}^{T} = \frac{{C}_{i}}{{t}_{i}^{T}} and {P}_{i}^{I} = \frac{{C}_{i}}{{t}_{i}^{I}}$$

In an embodiment, performance score generator 146 generates an overall performance score for a ML model i (Pᵢ=αPᵢ^{T}+βPᵢ^{l}), which is the weighted average of a training performance score (Pᵢ^{T}) and an inference performance score (Pᵢ^{l}). The weights may be default weights that are established by an administrator or designer of system 100. Alternatively, the weights may be specified by an end-user of system 100. Thus, different end-users of system 100 may select different weights α and β. Again, the values of Pᵢ^{T} and Pᵢ^{l} may be standardized using z-score normalization.

In an embodiment, performance scores for a set of ML models may be generated concurrently with the generation of diversity scores for pairs of models in that set. The input that generation of a diversity score requires is output from the respective ML models in the corresponding pair. Once the output from one of those ML models is available, a performance score may also be generated for that ML model. Such parallel generation of the different metrics decreases the time for model selection.

### Optimization Problem

In an embodiment, the ML model selection problem is modeled as a Quadratic Unconstrained Binary Optimization (QUBO) problem in the form of:

$${min}_{s} {s}^{T} Q s = {\sum }_{i = 1}^{M} {\sum }_{j = i}^{M} {s}_{i} {Q}_{i j} {s}_{j} \qquad ( 1 )$$

where s∈{0, 1}^{M} is the vector (of size M) of binary decision variables such that sᵢ=1, if model i is selected, and sᵢ=0, otherwise. The upper triangular matrix Q is the matrix of quadratic biases for the optimization problem. This matrix is defined in a way such that the most desired solution minimizes the cost function. Matrix Q is defined by:

$${Q}_{i j} = \{ \begin{matrix}- ( γ {C}_{i} + α {P}_{i}^{T} + β {P}_{i}^{I} ) & 1 = j , \\ - D ( {o}_{i} , {o}_{j} ) & i < j , \\ 0 & otherwise .\end{matrix} \qquad ( 2 )$$

For the elements on the diagonal, increasing the correctness score and the performance scores results in lower (negative) values. Conversely, for off-diagonal elements, less diverse models result in higher agreement between their predictions, thereby producing larger values. Because the QUBO problem formulation effectively sums up all of these terms (for the ML models present in the ensemble), these two sets of terms compete with each other. In other words, if two models are very accurate, only one of them will be added to the ensemble if their predictions are similar, since their diversity will be low. As a result, the QUBO formulation allows for the automatic determination of not only which ML models should be included in the ensemble, but also how many, by finding the optimal compromise between these two competing objectives.

This QUBO problem may also be defined as an Ising model with a simple variable transformation and may be solved using a classical solver or a quantum solver. Ising and QUBO are two forms of writing the same optimization problem. Any binary optimization that can be formulated with one of these two forms, can be reformulated with the other form. Ising is commonly used in physics and while QUBO is commonly used in computer science. These two forms of formulation use different decision variables. Each of these variables can be considered as a function of the other one. Therefore, given a QUBO (Ising), it can be reformulated as an Ising (QUBO) by substituting the decision variables.

In an embodiment, although QUBO is defined as “unconstrained,” one or more constraints are added to a solver that solves the QUBO problem. Example constraints include a maximum/minimum number of ML models to select, a maximum/minimum number of ML models of a particular type (e.g., at least three binary trees or at most four neural networks), a minimum number of types of ML models in the selected subset (e.g., at least different types of ML models in the selected subset), each ML model having its own hyper-parameter values, conditions on such hyper-parameters, maximum/minimum training time, maximum/minimum inference time, and cost of computation of ML models.

### Example Algorithm

The following is an example algorithm that model selector 140 may implement.

First, matrix Q is defined as a M×M zero matrix and s is defined as a binary vector with size M, where M is the number of supervised ML models that have been generated and trained. Second, for each ML model i, a correctness score and/or a performance score is/are generated for model i.

Third, for each ML model i, and for each ML model j (where j starts at i), if i=j, then Qᵢⱼ is assigned a score that is based on the correctness score and/or the performance score(s) that were computed for model i (e.g., −(γCᵢ+αPᵢ^{T}+βPᵢ^{l}); otherwise, Qᵢⱼ is assigned a diversity score (e.g., −D(oᵢ, oⱼ)).

Fourth, the product of s^{T}Qs is optimized using, for example, a QUBO solver.

This example algorithm may result in selecting multiple ML models, i.e., when Σᵢ₌₁^{M}sᵢ>1. The selected ML models may then be used in an ensemble setup using hard or soft voters.

### Process Overview

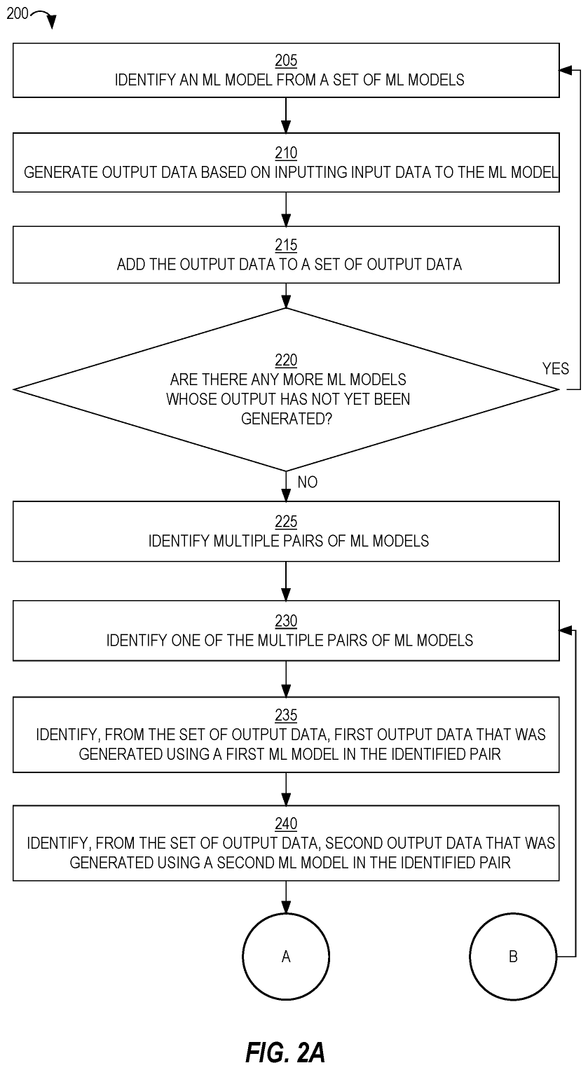

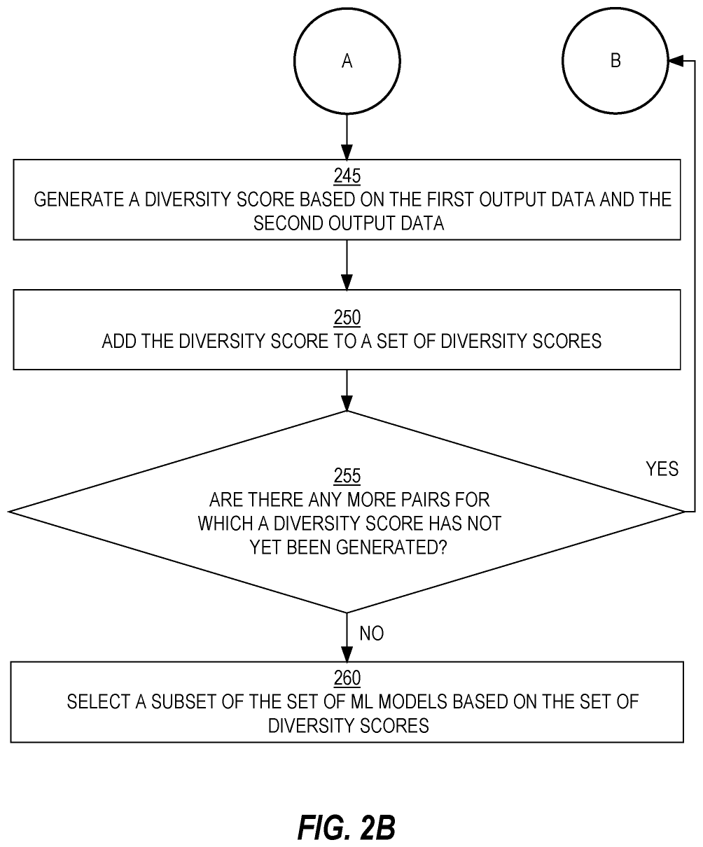

FIGS. 2A-2B are a flow diagram that depicts an example process 200 for selecting a strict subset of a set of ML models, in an embodiment. Process 200 may be performed by different components of model generation and selection system 100.

At block 205, an ML model is identified. Block 205 may involve model trainer 120 (or another component of system 100 not depicted) selecting an ML model from model database 130. The identified ML model may have been trained by model trainer 120. If this is the second or subsequent iteration of block 205, then the ML model that is identified is related to the previous ML model(s) that have been identified in that they have been trained based on the same set of training data, which may be stored in training data 110. If model database 130 stores ML models that were trained on different training data (e.g., the ML models generate very different output or predict very different things), then each iteration of block 205 in process 200 is limited to identifying an ML model in a particular set of ML models that were trained based on the same training data.

At block 210, output data is generated based on inputting input data to the identified ML model. Block 210 may involve model trainer 120 (or another component) invoking the identified ML model with the input data as input. The input data may comprise multiple instances of input so that the output data comprises multiple instances of output.

At block 215, the output data is added to a set of output data, which is initially empty when process 200 begins. In other words, the output data is “remembered” or stored for later use, particular in blocks 235 and 240. Block 215 may involve storing, in association with the identified ML model, data that indicates that output from the identified ML model has already been generated.

At block 220, it is determined whether there are any more ML models whose output has not yet been generated. If so, then process 200 returns to block 205; otherwise, process 200 proceeds to block 225. When block 225 is entered, the set of output data includes the output data of each ML model in a set of ML models from which a strict subset will be selected using process 200. Block 220 may involve determining whether any ML models in a particular set of ML models is not associated with data indicating that output data has been generated for that ML model.

At block 225, multiple pairs of ML models are identified. Each ML model in the multiple pairs of ML models is from the set of ML models. If there are M ML models, then there may be up to M-1 pairs that includes a particular ML model.

At block 230, one of the multiple pairs is identified. Such identification may be random or based on a certain order.

At block 235, from the set of output data, first output data that was generated by a first ML model in the identified pair is identified.

At block 240, from the set of output data, second output data that was generated by a second ML model in the identified pair is identified.

At block 245, a diversity score is generated that is based on the first output data and the second output data. The diversity score reflects how different the respective output data of the two ML models are.

At block 250, the diversity score is added to a set of diversity scores, which is initially zero when process 200 begins. In other words, the diversity score will be “remembered” or stored for later use, particularly block 260.

At block 255, it is determined whether there are any more pairs for which a diversity score has not yet been generated. If so, then process 200 returns to block 230; otherwise, process 200 proceeds to block 260.

At block 260, a subset of the set of ML models is selected based on the set of diversity scores. If process 200 includes computing a correctness score and/or one or more performance scores for each ML model, then block 260 involves selecting the subset also based on those scores.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

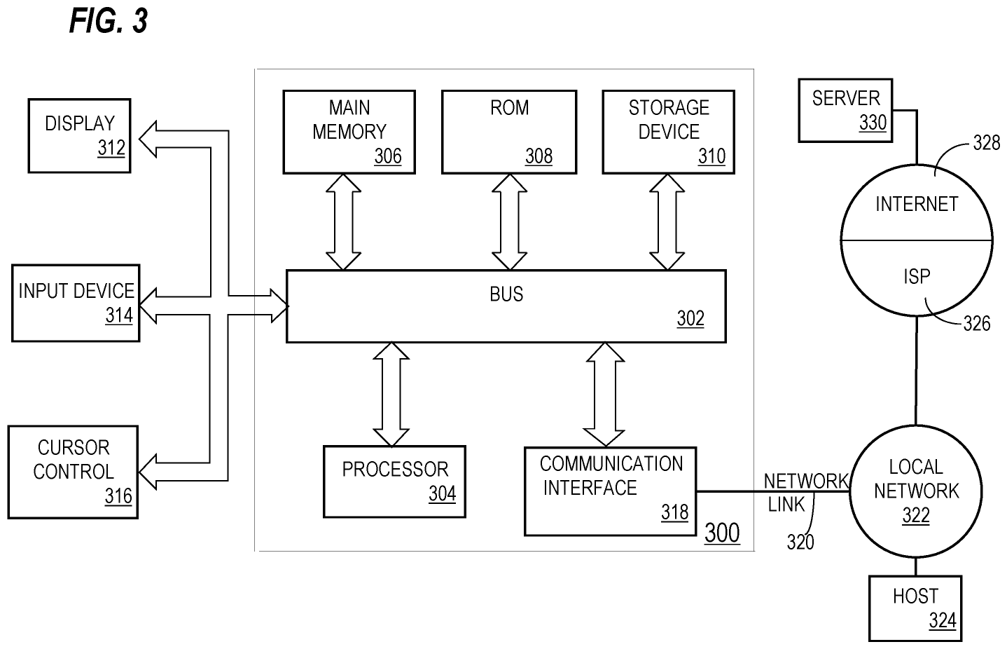

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic, or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the worldwide packet data communication network now commonly referred to as the “Internet” 328. Local network 322 and Internet 328 both use electrical, electromagnetic, or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

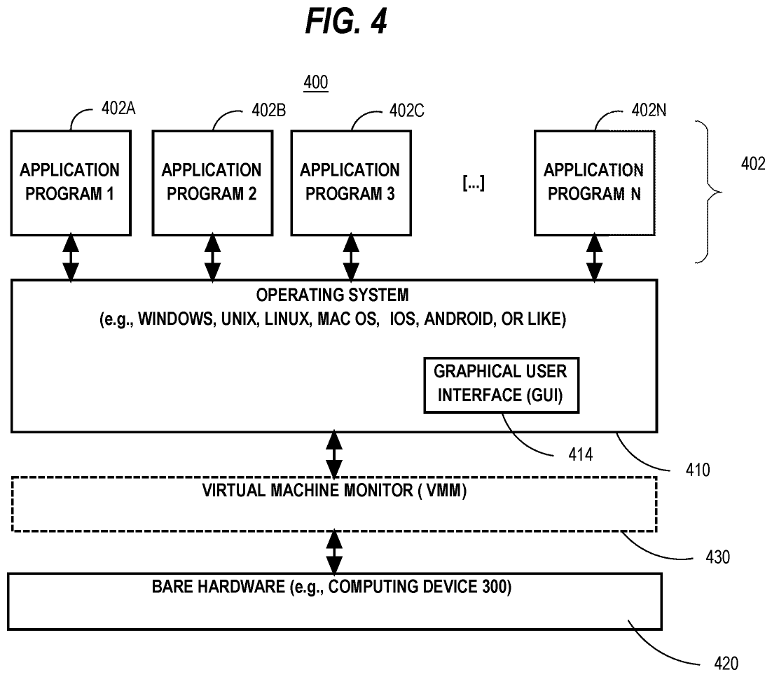

FIG. 4 is a block diagram of a basic software system 400 that may be employed for controlling the operation of computer system 300. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computer system 300. Software system 400, which may be stored in system memory (RAM) 306 and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 310 into memory 306) for execution by the system 400. The applications or other software intended for use on computer system 300 may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 304) of computer system 300. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 300.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 300 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (Saas), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
for each ML model of a plurality of ML models:
generating, based on input data to said each ML model, output data;
adding the output data to a set of output data;
wherein the set of output data includes the output data of each ML model in the plurality of ML models;
identifying a plurality of pairs of ML models, wherein each ML model in the plurality of pairs of ML models is from the plurality of ML models;
for each pair of ML models in the plurality of pairs of ML models:
identifying, from the set of output data, first output data that was generated by a first ML model in said each pair;
identifying, from the set of output data, second output data that was generated by a second ML model in said each pair;
generating a diversity value that is based on the first output data and the second output data;
adding the diversity value to a set of diversity values;
selecting a subset of the plurality of ML models based on the set of diversity values;
wherein the method is performed by one or more computing devices.

2. The method of claim 1, further comprising:
for each ML model in the plurality of ML models, generating a correctness value of said each ML model;
wherein selecting the subset is further based on the correctness value of each ML model of the plurality of ML models.

3. The method of claim 2, further comprising:
for each ML model in the plurality of ML models, generating a performance value of said each ML model that is based on the correctness value of said each ML model and a time value of said each ML model, the time value being one of (a) a time to train said each ML model or (b) a time to generate an output based on an input to said each ML model;
wherein selecting the subset is further based on the performance value of each ML model of the plurality of ML models.

4. The method of claim 3, wherein the performance value of said each ML model is a first performance value, wherein the time value is a first time value and is the time to train said each ML model, the method further comprising:
for each machine-learned model in the plurality of ML models, generating a second performance value of said each ML model that is based on the correctness value of said each ML model and a second time value of said each ML model, the second time value being the time to generate one or more outputs based on one or more inputs to said each ML model;
wherein selecting the subset is further based on the performance value of each ML model of the plurality of ML models.

5. The method of claim 1, further comprising:
for each ML model of the plurality of ML models, generating a correctness value or a performance value of said each ML model;
storing a plurality of weights that includes a first weight and a second weight that is different than the first weight, wherein the first weight is associated with the diversity value and the second weight is associated with the correctness value or the performance value;
prior to selecting the subset, for each pair of ML models of the plurality of ML models:
applying the first weight to each instance of the diversity value to generate modified diversity values;
applying the second weight to each instance of the correctness value or the performance value to generate modified correctness values or modified performance values;
wherein selecting the subset is further based on the modified diversity values and the modified correctness values or the modified performance values.

6. The method of claim 5, further comprising receiving user input that specifies the plurality of weights.

7. The method of claim 1, wherein:
adding the diversity value to the set of diversity values comprising adding the diversity value to a cell in a matrix, of a plurality of cells, whose dimension is the number of ML models in the plurality of ML models;
the coordinates of the cell in the matrix is determined based on a first number assigned to the first ML model and a second number assigned to the second ML model;
selecting the subset comprising executing a Quadratic Unconstrained Binary Optimization (QUBO) solver relative to the matrix.

8. The method of claim 1, wherein selecting the subset comprises selecting the subset such that:
the number of ML models in the subset does not exceed a first number;
the number of ML models in the subset is not less than a second number;
the number of ML models, in the subset, of a particular type does not exceed a third number;
the number of ML models, in the subset, of the particular type is not less than a fourth number;
the number of types of ML models in the subset is not less than a fifth number; or
the number of ML models in the subset equals an odd number.

9. The method of claim 1, further comprising:
generating a z-score for each diversity value in the set of diversity values;
wherein selecting the subset is further based on the z-score of each diversity value in the set of diversity values.

10. The method of claim 1, further comprising:
using a first machine learning training technique to train a first particular ML model in the plurality of ML models;
wherein training the first particular ML model comprises training the first particular ML model based on a first set of hyperparameters;
using the first machine learning training technique to train a second particular ML model in the plurality of ML models;
wherein training the second particular ML model comprises training the second particular ML model based on a second set of hyperparameters that is different than the first set of hyperparameters.

11. The method of claim 1, further comprising:
using a first machine learning training technique to train a first particular ML model in the plurality of ML models;
wherein the first particular ML model is a first type of ML model;
using a second machine learning training technique, that is different than the first machine learning training technique, to train a second particular ML model in the plurality of ML models;
wherein the second particular ML model is a second type, of ML model, that is different than the first type.

12. One or more non-transitory storage media storing instructions which, when executed by one or more computing devices, cause:
for each ML model of a plurality of ML models:
generating, based on input data to said each ML model, output data;
adding the output data to a set of output data;
wherein the set of output data includes the output data of each ML model in the plurality of ML models;
identifying a plurality of pairs of ML models, wherein each ML model in the plurality of pairs of ML models is from the plurality of ML models;
for each pair of ML models in the plurality of pairs of ML models:
identifying, from the set of output data, first output data that was generated by a first ML model in said each pair;
identifying, from the set of output data, second output data that was generated by a second ML model in said each pair;
generating a diversity value that is based on the first output data and the second output data;
adding the diversity value to a set of diversity values;
selecting a subset of the plurality of ML models based on the set of diversity values.

13. The one or more storage media of claim 12, wherein the instructions, when executed by the one or more computing devices, further cause:
for each ML model in the plurality of ML models, generating a correctness value of said each ML model;
wherein selecting the subset is further based on the correctness value of each ML model of the plurality of ML models.

14. The one or more storage media of claim 13, wherein the instructions, when executed by the one or more computing devices, further cause:
for each ML model in the plurality of ML models, generating a performance value of said each ML model that is based on the correctness value of said each ML model and a time value of said each ML model, the time value being one of (a) a time to train said each ML model or (b) a time to generate an output based on an input to said each ML model;
wherein selecting the subset is further based on the performance value of each ML model of the plurality of ML models.

15. The one or more storage media of claim 14, wherein the performance value of said each ML model is a first performance value, wherein the time value is a first time value and is the time to train said each ML model, wherein the instructions, when executed by the one or more computing devices, further cause:
for each machine-learned model in the plurality of ML models, generating a second performance value of said each ML model that is based on the correctness value of said each ML model and a second time value of said each ML model, the second time value being the time to generate one or more outputs based on one or more inputs to said each ML model;
wherein selecting the subset is further based on the performance value of each ML model of the plurality of ML models.

16. The one or more storage media of claim 12, wherein the instructions, when executed by the one or more computing devices, further cause:
for each ML model of the plurality of ML models, generating a correctness value or a performance value of said each ML model;
storing a plurality of weights that includes a first weight and a second weight that is different than the first weight, wherein the first weight is associated with the diversity value and the second weight is associated with the correctness value or the performance value;
prior to selecting the subset, for each pair of ML models of the plurality of ML models:
applying the first weight to each instance of the diversity value to generate modified diversity values;
applying the second weight to each instance of the correctness value or the performance value to generate modified correctness values or modified performance values;
wherein selecting the subset is further based on the modified diversity values and the modified correctness values or the modified performance values.

17. The one or more storage media of claim 16, wherein the instructions, when executed by the one or more computing devices, further cause receiving user input that specifies the plurality of weights.

18. The one or more storage media of claim 12, wherein:
adding the diversity value to the set of diversity values comprising adding the diversity value to a cell in a matrix, of a plurality of cells, whose dimension is the number of ML models in the plurality of ML models;
the coordinates of the cell in the matrix is determined based on a first number assigned to the first ML model and a second number assigned to the second ML model;
selecting the subset comprising executing a Quadratic Unconstrained Binary Optimization (QUBO) solver relative to the matrix.

19. The one or more storage media of claim 12, wherein selecting the subset comprises selecting the subset such that:
the number of ML models in the subset does not exceed a first number;
the number of ML models in the subset is not less than a second number;
the number of ML models, in the subset, of a particular type does not exceed a third number;
the number of ML models, in the subset, of the particular type is not less than a fourth number;
the number of types of ML models in the subset is not less than a fifth number; or
the number of ML models in the subset equals an odd number.

20. The one or more storage media of claim 12, wherein the instructions, when executed by the one or more computing devices, further cause:
generating a z-score for each diversity value in the set of diversity values;
wherein selecting the subset is further based on the z-score of each diversity value in the set of diversity values.
